(19) United States
(12) Patent Application Publication
(10) Pub. No.: US 2009/0015593 A1
(43) Pub. Date: Jan. 15, 2009

(54) METHOD AND APPARATUS FOR AUTOMATICALLY CHANGING COLOR

(75) Inventors: Young-mi Kang, Yongin-si (KR); Hye-rin Kim, Seoul (KR); Ju-il Eom, Suwon-si (KR); Jung-kun Lee, Suwon-si (KR); Young-shil Jang, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/027,332

(22) Filed: Feb. 7, 2008

(30) Foreign Application Priority Data
Jul. 9, 2007 (KR) 10-2007-0068804

(51) Int. Cl. G09G 5/00

(52) U.S. Cl. 345/581

(57) ABSTRACT

Provided are a method and an apparatus for automatically changing a color of a user interface of an image displaying apparatus, and a computer readable recording medium storing a program for executing the method. The method of automatically changing the color includes: analyzing a color distribution of a predetermined image; determining a representative color based on the analyzed color distribution; and setting a color of a predetermined region in an apparatus displaying the image as the representative color.

### CROSS-REFERENCE TO RELATED PATENT APPLICATIONS

This application claims priority from Korean Patent Application No. 10-2007-0068804, filed on Jul. 9, 2007, in the Korean Intellectual Property Office, the disclosure of which is incorporated herein in its entirety by reference.

### BACKGROUND OF THE INVENTION

1. Field of the Invention

The present invention relates to a method and an apparatus for automatically changing colors of a user interface in an image displaying apparatus, and a computer readable recording medium storing a program for executing the method.

2. Description of the Related Art

Users of personal digital appliances tend to prefer a user interface that is user-friendly, and with which users can create their own menus, control skins, and change the menus or skins.

FIG. 1A shows an apparatus using a graphic frame according to the related art.

Referring to FIG. 1A, the user selects a desired image from the apparatus and sets the selected image as an initial screen image 110, and then, sets a desired graphic frame 120 among a few frames provided in a frame setting menu. However, since one must be selected as the initial screen image 110 among a limited number of images, the user might not be satisfied with the selection result. In addition, if the apparatus is set so that a color or a style of the frame cannot be changed, the user will also not be satisfied with the apparatus. In particular, as shown in FIG. 1A, if colors of a subject in a picture and of the graphic frame 120 are opposite to each other or do not match with each other, the dissatisfaction of the user increases. For example, if the frame of a picture around a blue car is red, the screen does not look good.

FIG. 1B shows an example of an apparatus using a light emitting diode (LED) keypad according to the related art.

Referring to FIG. 1B, the user uses the LED keypad 130 having the color that does not match with the user selected initial screen image 110. Then, the user will not be satisfied with the apparatus.

As described above, on the screen of a personal appliance such as a mobile phone, an MP3 (Moving Picture Experts Group Audio Layer 3) player, and an electronic picture frame, there are many cases where the initial screen image set by the user does not match with the color of the frame or the color of the color keypad. In addition, in some apparatuses, the user can manually change the color of the frame or the color of the keypad, however, it is inconvenient because the user must change the frame color or the keypad color whenever the initial screen image is changed. In addition, sometimes the image desired by the user does not match with the peripheral environment of the apparatus, and thus, the image cannot be changed even if the user wants to change the image.

### SUMMARY OF THE INVENTION

The present invention provides a method and apparatus for automatically changing a color of a predetermined region of an apparatus according to images selected by a user, and a computer readable recording medium storing a program for executing the method, and thus, a customized user interface suitable to the taste of the user can be provided.

According to an aspect of the present invention, there is provided a method of automatically changing a color, the method including: analyzing a color distribution of a predetermined image; determining a representative color based on the analyzed color distribution; and setting a color of a predetermined region of an apparatus displaying the image as the representative color.

The determination of the representative color may include: determining a color having the largest distribution among colors constituting the image as the representative color.

The setting of the color in the predetermined region may include: changing a color of at least a part of a keypad in the display apparatus into the representative color.

The keypad of the display apparatus may be a light emitting diode (LED) keypad, and the changing of the color of at least a part of the keypad may include: changing a color of an illumination light of the LED keypad into the representative color.

The setting of the color of the predetermined region may include: changing a color of a graphic frame of the image into the representative color.

The display apparatus may be an electronic picture frame, and the determination of the color of the predetermined region may include: changing a color of a frame in the electronic picture frame into the representative color.

The method may further include: setting a style of the predetermined region according to a selection of a user. The style may include at least one of a color, a texture, a pattern, and a shape of the predetermined region.

The image may be an initial screen image of the display apparatus. The method may be performed when the initial screen image is changed.

According to another aspect of the present invention, there is provided an apparatus for automatically changing a color of a predetermined image, the apparatus including: a color analyzing unit that analyzes a color distribution of the image and determines a representative color based on the analyzed result; and a color changing unit that sets a color of a predetermined region of an input unit or a display unit of the apparatus as the representative color.

### BRIEF DESCRIPTION OF THE DRAWINGS

The above and other features and advantages of the present invention will become more apparent by describing in detail exemplary embodiments thereof with reference to the attached drawings in which:

FIG. 1A is a diagram showing an apparatus using a graphic frame according to the related art;

FIG. 1B is a diagram showing an apparatus using an LED keypad according to the related art;

FIG. 2 is a block diagram showing an apparatus for automatically changing color according to an embodiment of the present invention;

FIG. 3 is a flowchart illustrating a method of automatically changing color according to an embodiment of the present invention;

FIG. 4 is a diagram showing an example of analyzing a color distribution according to an exemplary embodiment of the present invention;

FIG. 5 is a diagram showing an example of changing a color of a keypad according to the analyzing result of FIG. 4;

FIG. 6 is a diagram showing an example of changing a color of a graphic frame according to the analyzing result of FIG. 4; and

FIG. 7 is a diagram showing an example of changing a color of a frame in an electronic picture frame according to the analyzing result of FIG. 4.

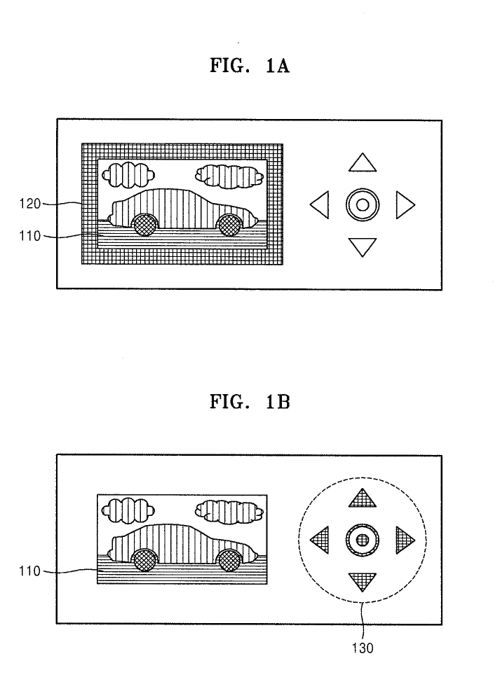

### DETAILED DESCRIPTION OF EXEMPLARY EMBODIMENTS OF THE INVENTION

Hereinafter, exemplary embodiments of the present invention will be described with reference to accompanying drawings.

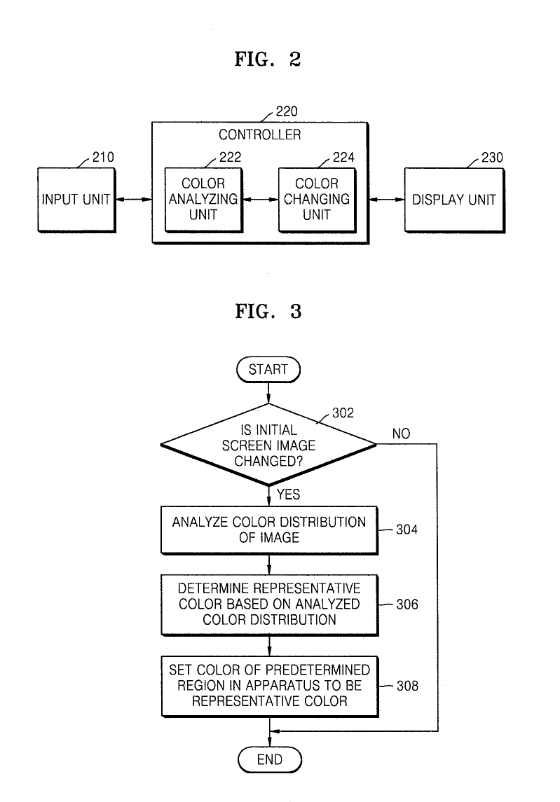

FIG. 2 is a block diagram of an apparatus for automatically changing a color according to an embodiment of the present invention.

Referring to FIG. 2, the automatic color changing apparatus includes an input unit 210 for receiving a user command, a display unit 230 outputting a result of the user command input, and a controller 220 including a color analyzing unit 222 analyzing a color distribution in a predetermined image and determining a representative color based on the analyzing result and a color changing unit 224 for setting a color of a predetermined region in the input unit 210 or the display unit 230 as the representative color, and controlling the entire apparatus.

In a case where the color of the input unit 210 is changed, an input device including an LED keypad that can be changed into various colors or a liquid crystal display (LCD) can be used as the input unit 210. In addition, in a case where the color of the display unit 230 is changed, a display unit supporting the colors such as a color LCD can be used. As described above, the present invention can be applied to the apparatus having a color LCD panel or an LED keypad, however, it is not limited thereto, and can be applied to apparatuses having other kinds of output devices or input devices. In addition, the present invention can be applied to all kinds of personal digital appliances reproducing multimedia files (for example, MP3 players, portable multimedia players (PMPs), mobile phones, personal digital assistances (PDAs), camcorders, or electronic dictionaries) and all kinds of electronic appliances including a color LCD (for example, televisions, electronic picture frames, or monitors). Hereinafter, the automatic color change performed by the controller 220 will be described with reference to FIGS. 3 through 7.

FIG. 3 is a flowchart illustrating a method of automatically changing a color according to an embodiment of the present invention.

An image that is to be analyzed is an initial screen image, that is, an image displayed on the apparatus initially when the apparatus is booted, however, it is not limited thereto, and an image displayed on the display unit 230 by a menu or a function of the apparatus can be analyzed. In a case where the initial screen image is to be analyzed, the color of a predetermined region in the apparatus is changed when the initial screen image is set or changed. Therefore, it is determined whether the initial screen image is set or changed using the input unit 210 (302).

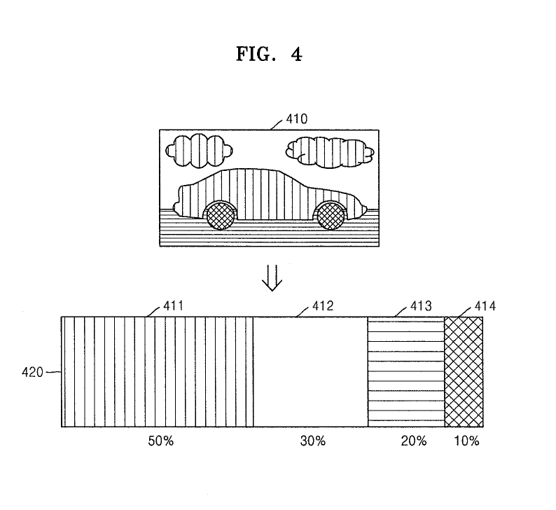

If the initial screen image is newly set, the color analyzing unit 222 analyzes a color distribution of the image (304). FIG. 4 shows an example of analyzing the color distribution according to an exemplary embodiment of the present invention. The colors constituting the image 410 are extracted, and distribution degrees of the colors are shown as a graph 420. Referring to FIG. 4, the image 410 includes 50% of a first color [symbol] (411), 30% of a second color (ε) (412), 20% of a third color [symbol] (413), and 10% of a fourth color [symbol] (414).

The color analyzing unit 222 determines the representative color based on the color distribution (306). The first color having the largest distribution among the colors constituting the object image 410 can be determined as the representative color. However, the determination of the representative color is not limited thereto, that is, the color having the intermediate distribution, the color having a saturation that is slightly lower than that of the color having the largest distribution, or the color that is similar to the color having the largest distribution among changeable colors can be selected as the representative color. In addition, another method or principle that can determine the color suitable for the frame of the input unit 210 or the object image 410 can be used. In addition, there is no need to determine only one representative color. For example, two colors having high distribution can be selected as representative colors. In this case, a predetermined pattern image consisting of the selected colors can be used to change the frame of the object image 410.

The color changing unit 224 sets the color of the predetermined region as the representative color determined by the color analyzing unit 222 (308). The predetermined region can be different in each embodiment, for example, at least a portion of the keypad that is the input unit 210 of the apparatus or the graphic frame of the image 410 can be the region. In addition, in a case where the apparatus has an electronic picture frame, the frame around the object image 410 can be the region, the color of which is changed.

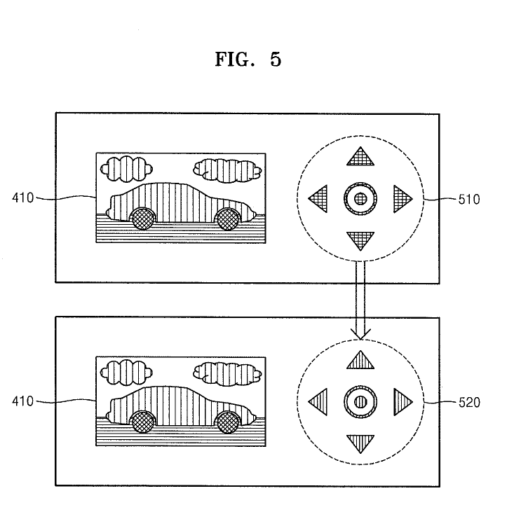

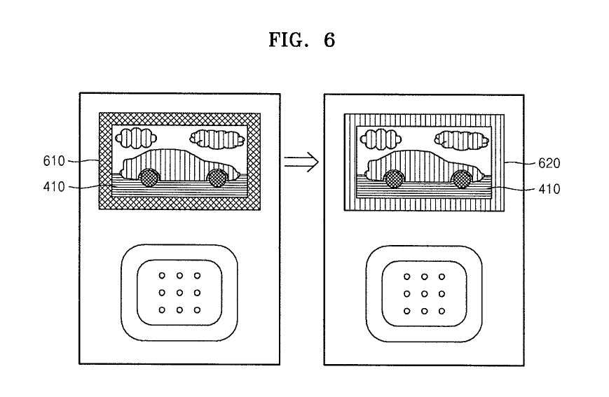

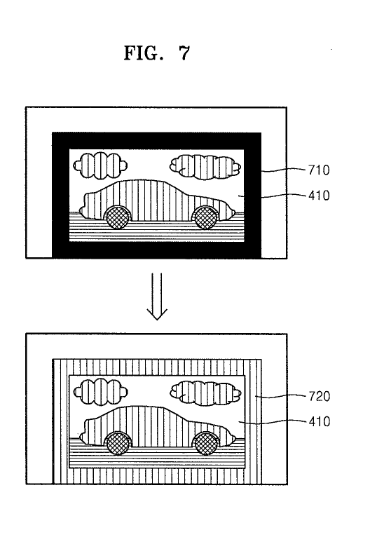

FIG. 5 shows an example of changing the color of the keypad according to the analyzing result of FIG. 4. Referring to FIG. 5, the color of the keypad is changed from [symbol] (510) to the representative color [symbol] (520) having the largest distribution. In a case of the LED keypad, an illumination color of the keypad can be changed into the representative color. Consequently, the color of the keypad 520 can be changed so as to match with the image 410, and thus, the user can be satisfied with the color arrangement of the device. FIG. 6 shows an example of changing the color of the graphic frame according to the analyzing result of FIG. 4. Referring to FIG. 6, the color of the graphic frame in the LCD window is changed from the color [symbol] (610) to the representative color [symbol] (620). FIG. 7 shows an example of changing the color of the frame in the electronic picture frame according to the analyzing result of FIG. 4. Referring to FIG. 7, the frame color of the electronic picture frame is changed from the basic color ▪(710) to the representative color [symbol] (720) that is determined by analyzing the image 410.

In a case where a predetermined style is applied to the keypad or the frame, only the color can be changed without changing the style. The style includes at least one of a color, a texture, a pattern, or a shape of the corresponding region, for example, the style can be the frame of a steel texture, a wooden frame, or an antique style frame. If the frame is set as the wooden frame by the style setting, the color is only changed into the representative color while maintaining the wooden frame style. In addition, the user can additionally set the color or the style of the keypad or the frame, or change the color into the color that is different from the representative color through a manual operation. For example, if the user does not like the color of the frame, which is changed automatically into the representative color, the user can change the color into other colors, and can apply a desired style to the frame, the color of which is changed automatically into the representative color.

The invention can also be embodied as computer readable codes on a computer readable recording medium.

According to the present invention, the problem that the image set by the user and the apparatus do not match with each other in terms of color can be solved.

In addition, in a case of the electronic picture frame, when the image does not match the picture frame, the frame can be automatically changed into the frame that matches with the displayed image.

In addition, since the color of the frame or the keypad can be automatically changed according to the change of images, it seems that the color of the apparatus is changed according to the mood of the user or the peripheral environment of the apparatus, and thus, the user can be emotionally satisfied.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of automatically changing a color, the method comprising:
analyzing a color distribution of a predetermined image;
determining a representative color based on the analyzed color distribution; and
setting a color of a predetermined region of an apparatus displaying the image as the representative color.

2. The method of claim 1, wherein the determining a representative color comprises:
determining a color having the largest distribution among colors constituting the image as the representative color.

3. The method of claim 1, wherein the setting of a color of a predetermined region comprises:
changing a color of at least a part of a keypad in the apparatus displaying the image into the representative color.

4. The method of claim 3, wherein the keypad of the apparatus displaying the image is a light emitting diode (LED) keypad, and the changing a color of at least a part of the keypad comprises:
changing a color of an illumination light of the LED keypad into the representative color.

5. The method of claim 1, wherein the setting a color of a predetermined region comprises:
changing a color of a graphic frame of the image into the representative color.

6. The method of claim 1, wherein the apparatus displaying the image is an electronic picture frame, and the determining a representative color of a predetermined region comprises:
changing a color of a frame in the electronic picture frame into the representative color.

7. The method of claim 1, further comprising:
setting a style of the predetermined region according to a selection of a user.

8. The method of claim 7, wherein the style includes at least one of a color, a texture, a pattern, and a shape of the predetermined region.

9. The method of claim 1, wherein the image is an initial screen image of the apparatus displaying the image.

10. The method of claim 9, wherein the method is performed when the initial screen image is changed.

11. A computer readable recording medium having embodied thereon a computer program for executing the method of claim 1.

12. An apparatus for automatically changing a color of a predetermined image, the apparatus comprising:
a color analyzing unit that analyzes a color distribution of the image and determines a representative color based on the analyzed result; and
a color changing unit that sets a color of a predetermined region of an input unit or a display unit of the apparatus as the representative color.

13. The apparatus of claim 12, wherein the color analyzing unit determines a color having the largest distribution among colors constituting the image as the representative color.

14. The apparatus of claim 12, wherein the color changing unit changes a color of at least a part of a keypad of the input unit of the apparatus into the representative color.

15. The apparatus of claim 14, wherein the keypad is an LED keypad, and the color changing unit changes a color of an illumination light of the LED keypad into the representative color.

16. The apparatus of claim 12, wherein the color changing unit changes a color of a graphic frame of the image displayed on the display unit into the representative color.

17. The apparatus of claim 12, wherein the apparatus is an electronic picture frame, and the color changing unit changes a color of a frame in the electronic picture frame into the representative color.

18. The apparatus of claim 12, wherein the color changing unit sets a style of the predetermined region according to an input by a user, which is received through the input unit.

19. The apparatus of claim 18, wherein the style includes at least one of a color, a texture, a pattern, and a shape of the predetermined region.

20. The apparatus of claim 12, wherein the image is an initial screen image displayed on the display unit of the apparatus.

21. The apparatus of claim 20, wherein the color changing unit changes the color of the predetermined region when the initial screen image is changed.
